(19) United States
(12) Patent Application Publication
(10) Pub. No.: US 2018/0118242 A1
(43) Pub. Date: May 3, 2018

(54) Hand Truck Nose Extension Device

(71) Applicant: Pollard, Johnston & Berry, LLC, Loraine, TX (US)

(72) Inventors: Gene Pollard, Snyder, TX (US); Jason Johnston, Loraine, TX (US); Kenneth Darrel Pollard, Snyder, TX (US)

(73) Assignee: Pollard, Johnston & Berry, LLC, Loraine, TX (US)

(21) Appl. No.: 15/786,160

(22) Filed: Oct. 17, 2017

Related U.S. Application Data
(60) Provisional application No. 62/416,961, filed on Nov. 3, 2016.

(51) Int. Cl. B62B 1/04

(52) U.S. Cl. CPC B62B 1/04; B62B 2206/02

(57) ABSTRACT

A hand truck nose extension device and a method of use are disclosed herein. The disclosed device generally comprises a top surface, a bottom surface, and a hand truck nose receiving slot disposed between the top surface and the bottom surface, the hand truck nose receiving slot being arranged and configured for receiving and retaining a load supporting nose of a conventional hand truck. The disclosed hand truck nose extension device may be utilized to support and transport large, bulky and/or heavy loads using a conventional hand truck.

### CROSS-REFERENCE TO RELATED APPLICATIONS

This application is related to and claims priority from earlier filed U.S. Provisional Patent Application No. 62/416,961, filed Nov. 3, 2016, the disclosure of which is incorporated herein by reference.

### BACKGROUND OF THE INVENTION

### 1. Field of the Invention

The present invention generally relates to hand trucks. More specifically, the present invention relates to a hand truck nose extension device that quickly and easily slides onto the load supporting nose of a conventional hand truck.

### 2. Description of Related Art

A manual hand truck, also commonly referred to as a hand dolly or hand trolley, is an L-shaped box-moving handcart. It is well known to provide hand trucks for lifting multiple stacked boxes and other heavy objects from a location and transporting those objects to a different location. A conventional hand truck comprises an elongated frame having a handle mounted or formed at an upper end thereof, a load supporting nose or platform that extends perpendicularly from a lower end thereof, and a pair of wheels connected to the frame by an axle. The load supporting nose is provided at the lower portion of the frame for sliding under the object to be moved. In use, when a user pulls the handle toward himself or herself, the load supporting nose pivots upwardly and the frame is supported from the ground entirely by the wheels.

In use, a conventional hand truck is manipulated by a user so that the load supporting nose is positioned underneath the object to be lifted and moved. To maneuver the load, the user tilts the frame rearwardly into an inclined position to lift the load supporting nose and the load carried thereon from the ground so that the load is supported from the ground by the wheel assembly. In this position, the weight of the load is supported by the frame and the wheels, and the user is able to wheel the hand truck to a desired location.

Hand trucks were designed for moving relatively small loads, especially multiple boxes stacked on top of one another. As a result, conventional hand trucks are designed with a relatively small-sized load supporting nose. Such a design aids in transporting hand trucks and in storing hand trucks in small spaces. In many cases, however, it is desirable to have a hand truck with an extended load supporting nose that provides a greater surface area for supporting a large, heavy or bulky load.

While hand truck nose extension devices are available, all current devices must be bolted onto a hand truck or permanently affixed to a hand truck. Such a modification is time consuming and permanently alters the hand truck. Additionally, while extending the length and/or width of the load supporting nose is oftentimes desirable, there remain several situations in which an extended load supporting nose is undesirable. For example, during storage of the hand truck or when moving small loads, it may be desirable to have the conventional small-sized load supporting nose. Therefore, permanently altering the size of the load supporting nose is not desirable in most situations.

Currently, a need exists for a hand truck nose extension device that can quickly and easily slide onto and off of the load supporting nose of a conventional hand truck device. A hand truck nose extension device is needed that can support large, heavy loads. Unlike existing devices that must be permanently affixed to a hand truck, a need exists for a device that does not permanently alter the hand truck device on which it is used.

In view of the foregoing, it is apparent that a need exists in the art for a hand truck nose extension device which overcomes, mitigates or solves the above problems in the art. It is a purpose of this invention to fulfill this and other needs in the art which will become more apparent to the skilled artisan once given the following disclosure.

### OBJECTS AND SUMMARY OF THE INVENTION

It is an object of the present invention to overcome the above described drawbacks associated with current devices. To achieve these and other advantages and in accordance with the purpose of the invention, as embodied and broadly described, the present disclosure describes a hand truck nose extension device comprising a nose extension device that quickly and easily slides onto and off of the load supporting nose of a conventional hand truck.

By utilizing a lightweight, detachable one-piece nose extension device, the disclosed device provides a quick and easy method for extending the load supporting nose of a conventional hand truck without permanently modifying the hand truck. The disclosed device does not require tools, hardware, or fasteners to attach the device to a hand truck. Unlike current nose extension devices which must be permanently bolted onto or otherwise permanently affixed to a conventional hand truck using tools and hardware, the disclosed device simply slides onto the nose of a conventional hand truck when a user desires to extend the nose. Then, the disclosed device simply slides off the hand truck nose when the user no longer desires to have an extended nose portion on the hand truck.

Extending the load supporting nose of a conventional hand truck provides a larger platform for moving large and/or bulky loads. By extending the point of leverage of a conventional hand truck, the disclosed device provides enhanced stability for large loads. This in turn provides for a safer method of moving large loads and decreases the risk of user injury, which may occur while loading or moving large or heavy loads with conventional hand trucks.

These, together with other objects of the invention, along with various features of novelty that characterize the invention, are pointed out with particularity in the claims annexed hereto and forming a part of this disclosure. For a better understanding of the invention, its operating advantages, and the specific objects attained by its uses, reference should be had to the accompanying drawings and descriptive matter in which there is described illustrative embodiments of the invention.

### BRIEF DESCRIPTION OF THE DRAWINGS

The accompanying drawings, which are incorporated in and forma part of the specification, illustrate embodiments of the present invention, and together with the description, serve to explain the principles of the invention. It is to be expressly understood that the drawings are for the purpose of illustration and description only and are not intended as a definition of the limits of the invention. In the drawings:

FIG. 1 is a top view of a device constructed in accordance with the teachings of the present disclosure.

FIG. 2 is a side view of a device constructed in accordance with the teachings of the present disclosure.

FIG. 3 is a rear view of a device constructed in accordance with the teachings of the present disclosure.

FIG. 4 is a side view of a device constructed in accordance with the teachings of the present disclosure.

FIG. 5 is a top view of a device constructed in accordance with the teachings of the present disclosure.

FIG. 6 is a top perspective view of a device constructed in accordance with the teachings of the present disclosure.

FIG. 7 is a top perspective view of a device constructed in accordance with the teachings of the present disclosure.

FIG. 8 is a bottom perspective view of the device shown in FIG. 7.

FIG. 9 is a bottom perspective view of a device constructed in accordance with the teachings of the present disclosure.

FIG. 10 is a top view of the device shown in FIG. 9.

FIG. 11 is a bottom perspective view of a device constructed in accordance with the teachings of the present disclosure.

FIG. 12 is a bottom perspective view of the device shown in FIG. 11.

FIG. 13 is a top perspective view of a device constructed in accordance with the teachings of the present disclosure.

FIG. 14 is a top perspective view of a device constructed in accordance with the teachings of the present disclosure, wherein the device is inserted onto the load supporting nose of a conventional hand truck.

### DETAILED DESCRIPTION OF ILLUSTRATIVE EMBODIMENTS

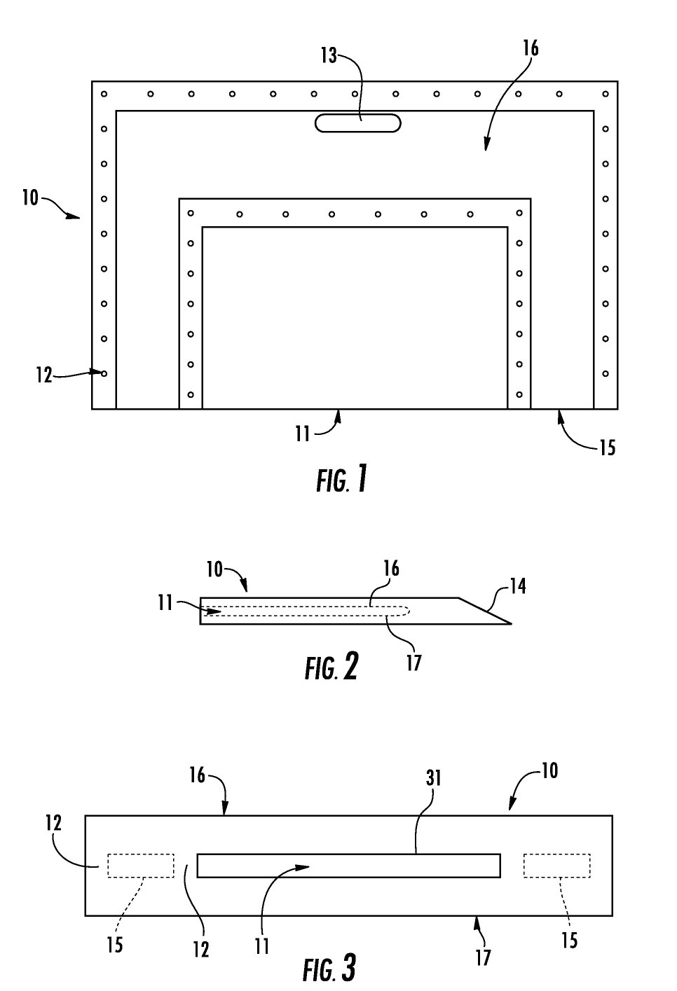

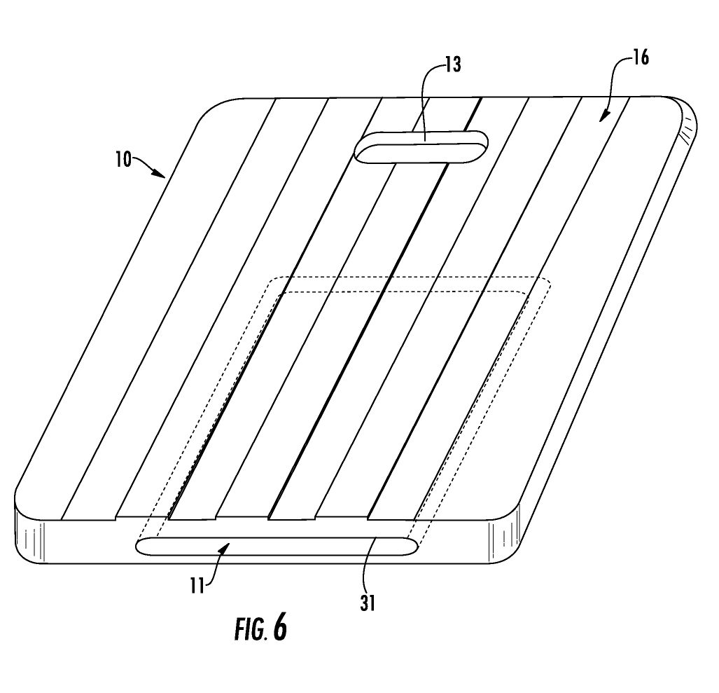

Referring now to FIGS. 1-14, exemplary embodiments are illustrated of a hand truck nose extension device in accordance with the present disclosure.

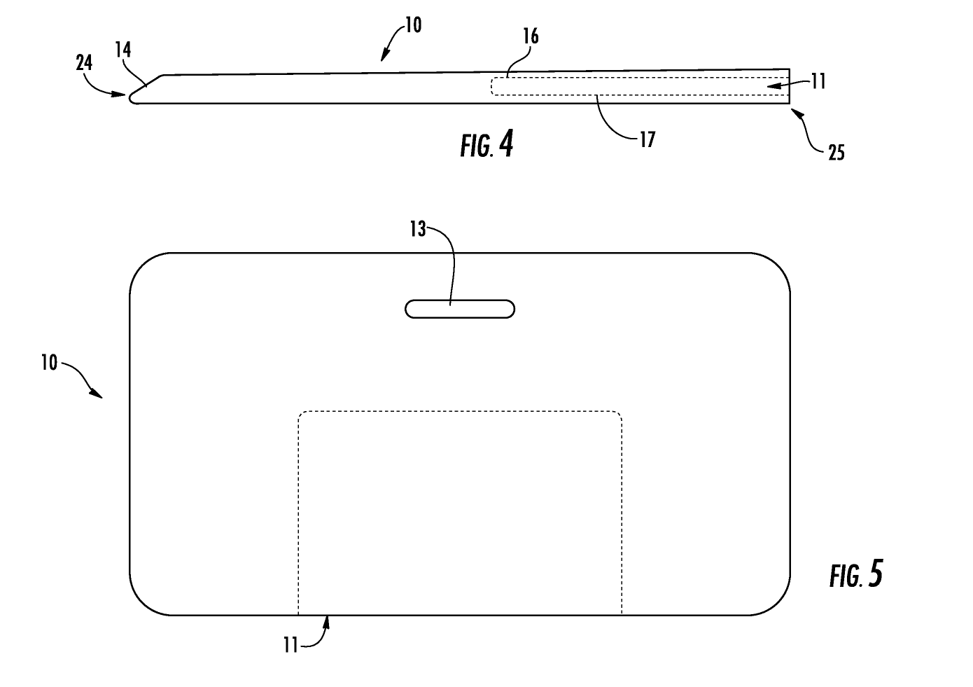

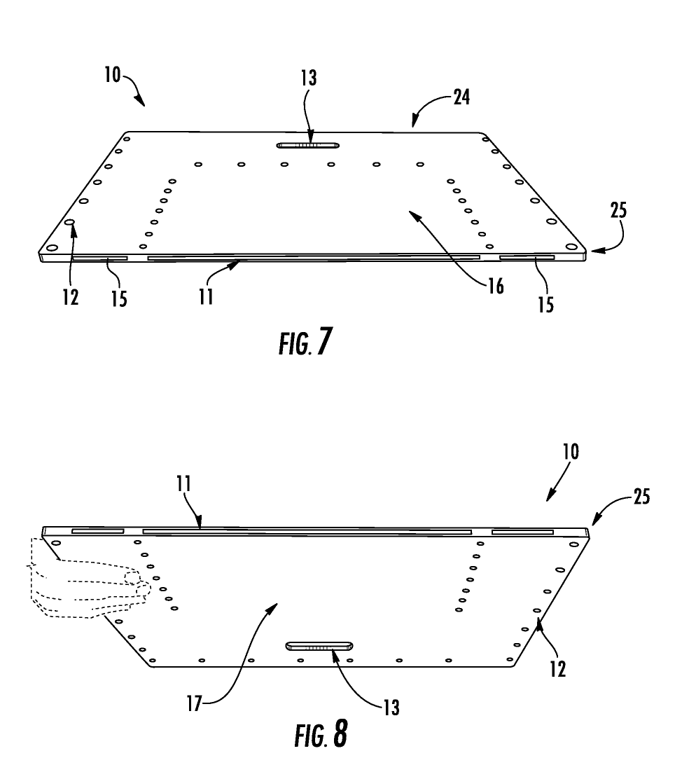

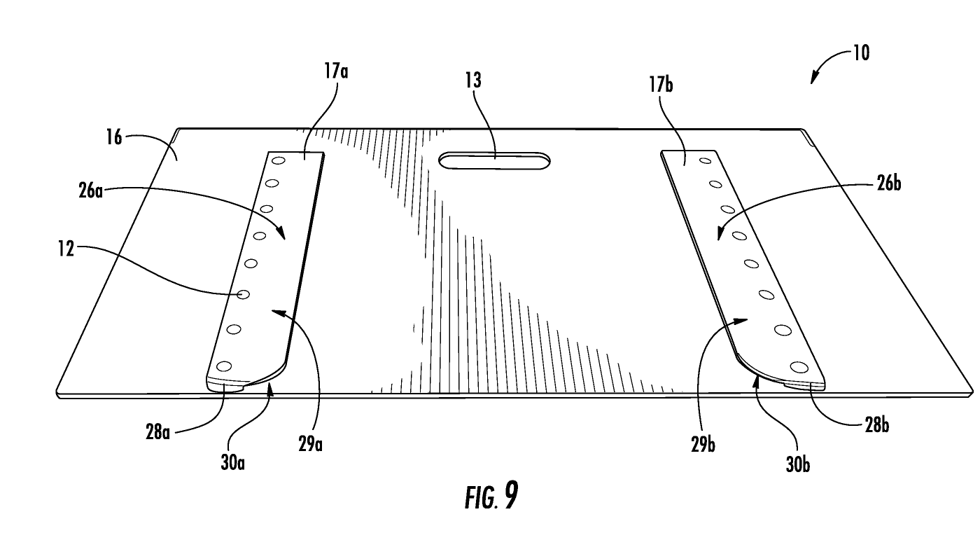

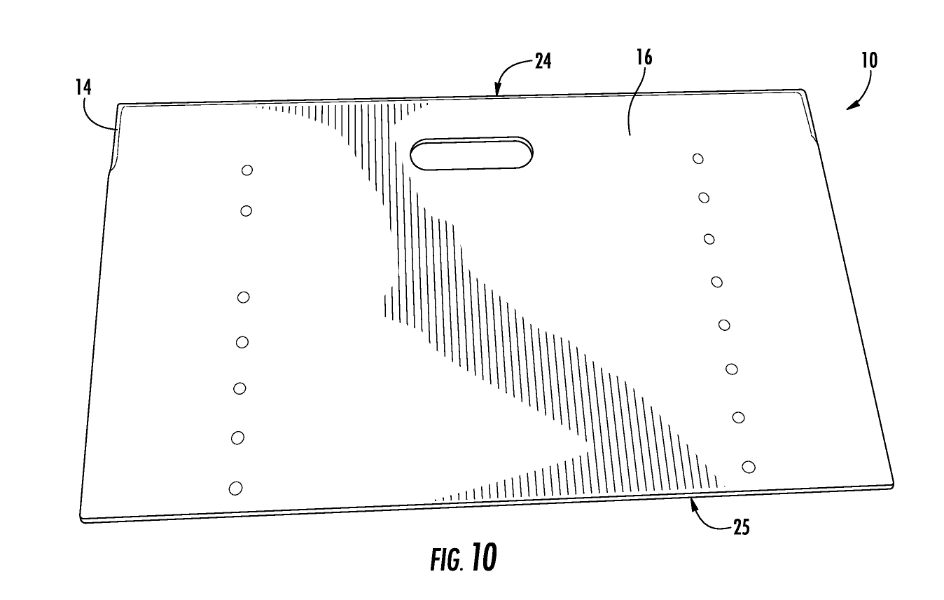

Turning to FIGS. 7 and 8, a hand truck nose extension device 10 according to the present disclosure is illustrated and generally includes a top surface 16; a bottom surface 17; and a hand truck nose receiving slot 11 formed at a proximal end 25 of the device and disposed between the top surface and the bottom surface, the hand truck nose receiving slot being arranged and configured for receiving and retaining a load supporting nose of a conventional hand truck. The disclosed device may further include a handle 13 for carrying the device when it is not attached to the load supporting nose of a hand truck. As shown in FIGS. 2, 4, 10 and 14, the disclosed device may further include an inclined or angled edge 14 forming an acute angle at the distal end 24 of the device, which is configured for sliding the distal end 24 of the nose extension device 10 under a load to be carried by a hand truck.

The disclosed device 10 may be made of aluminum, plastic, steel or any other material suitable for constructing the device disclosed herein. In one embodiment contemplated by the present disclosure, the disclosed device is made of two sheets of aluminum or steel. One sheet forms the top surface 16 defining a flat planar surface and the other sheet forms the bottom surface 17 defining a flat planar surface. The top surface 16 may include one or more textured or nonslip portions to create friction points and provide additional stability when carrying loads using the disclosed device. In this embodiment, the top surface and the bottom surface may be permanently joined together by rivets 12, as shown in FIGS. 1, 7 and 8. In other embodiments, the top surface and the bottom surface may be permanently joined together by other fasteners, by welding, or by any other means known to those skilled in the art. In alternative embodiments, the top surface and the bottom surface may be non-permanently joined together by fasteners or by any other means known to those skilled in the art. In the embodiment shown in FIGS. 1-8, the top surface and the bottom surface are joined together in a manner which forms one or more openings between the two surfaces. FIGS. 1, 7 and 8 illustrate the openings surrounded by rivets or other fasteners in order to create a hand truck nose receiving slot 11 between the top surface and the bottom surface, wherein the hand truck nose receiving slot 11 is arranged and configured to receive the load supporting nose of a conventional hand truck. In this embodiment, the hand truck nose receiving slot 11 retains the load supporting nose 19 of a conventional hand truck in the hand truck nose receiving slot 11 by the frictional contact of the top surface 16 and the bottom surface 17 against the nose 19 of the hand truck. The hand truck nose receiving slot 11 is sized to receive and retain a hand truck nose 19 using only such frictional contact. This embodiment may further include one or more hollow spaces 15 between the top surface 16 and the bottom surface 17 of the device. Such an embodiment would decrease the weight and materials required to construct the disclosed device.

In another embodiment contemplated by the present disclosure and illustrated in FIG. 6, the disclosed device may be made of plastic. The depicted embodiment includes a top surface shaped into alternate ridges and grooves. Corrugated plastic may be used to create such a top surface. Such a surface creates friction points providing additional stability when carrying loads using the disclosed nose extension device 10.

In a further embodiment contemplated by the present disclosure, the hand truck nose receiving slot 11 between the top surface 16 and the bottom surface 17 may have a corrugated surface forming the inner surface 31 surrounding the hand truck nose receiving slot 11. In another embodiment, the hand truck nose receiving slot 11 may include mesh or another material known to those skilled in the art for more securely retaining the disclosed device on the load supporting nose 19 of a hand truck 18 without permanently attaching the disclosed device 10 to the hand truck nose 19.

In one embodiment contemplated by the present disclosure, the disclosed device 10 measures approximately 24 inches long by 14 inches wide by 9/16 inches tall. In this embodiment, the hand truck nose receiving slot 11 for receiving the load supporting nose 19 of a conventional hand truck 18 measures 14⅛ inches long by 8 inches wide by 3/16 inches tall. Those skilled in the art will appreciate that in alternative embodiments, the disclosed device 10 may be provided in various sizes suitable for the device 10 as disclosed herein.

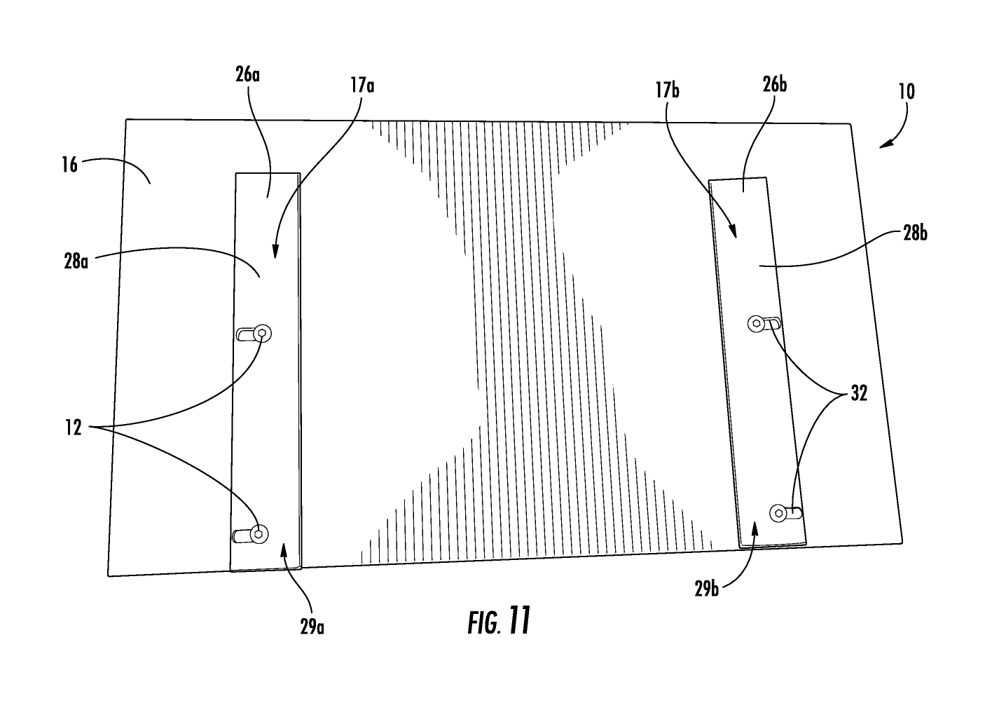

Turning to FIGS. 9 and 10, another embodiment of the disclosed device is illustrated and generally includes a top surface 16; a first retaining member 26a including a first retaining bar 28a fixed to the top surface 16, and a first retaining lip 29a extending from the first retaining bar, the first retaining lip defining a longitudinally extending bottom surface 17a; a first longitudinal channel 30a formed between the top surface 16 and the first retaining lip 29a; a second retaining member 26b including a second retaining bar 28b fixed to the top surface 16, and a second retaining lip 29b extending from the second retaining bar, the second retaining lip defining a longitudinally extending bottom surface 17b; and a second longitudinal channel 30b formed between the top surface 16 and the second retaining lip 29b; wherein the first longitudinal channel 30a and the second longitudinal channel 30b define a hand truck nose receiving slot 11 for receiving and retaining a load supporting nose 19 of a conventional hand truck 18. As shown in FIGS. 9 and 10, the disclosed device may further include a handle 13 for carrying the device and an inclined or angled edge 14 at the distal end 24 of the device 10 for sliding the distal end of the device under a load to be carried by a hand truck.

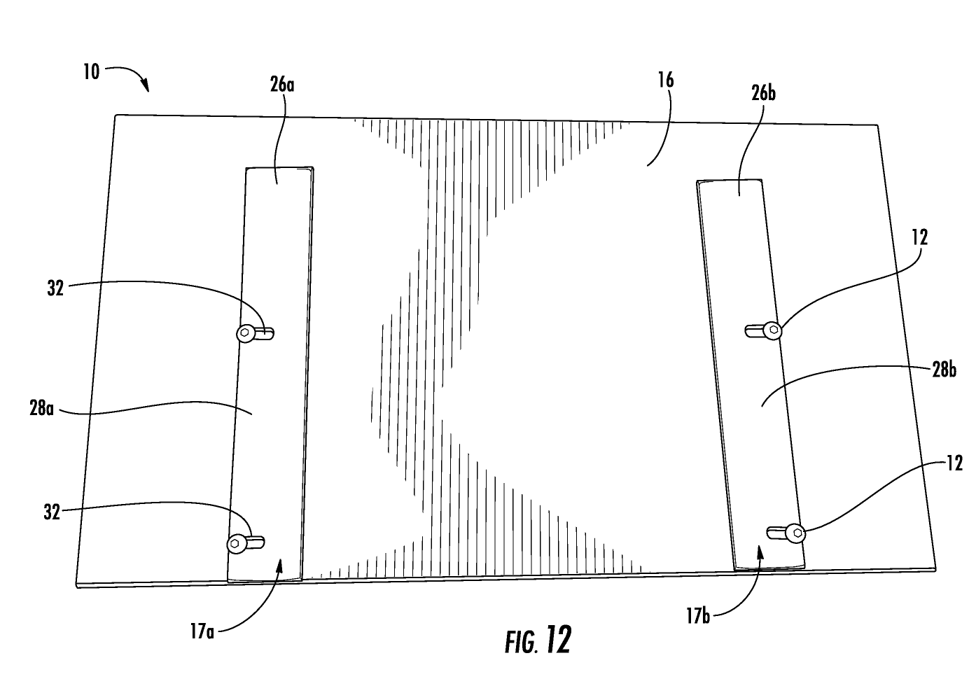

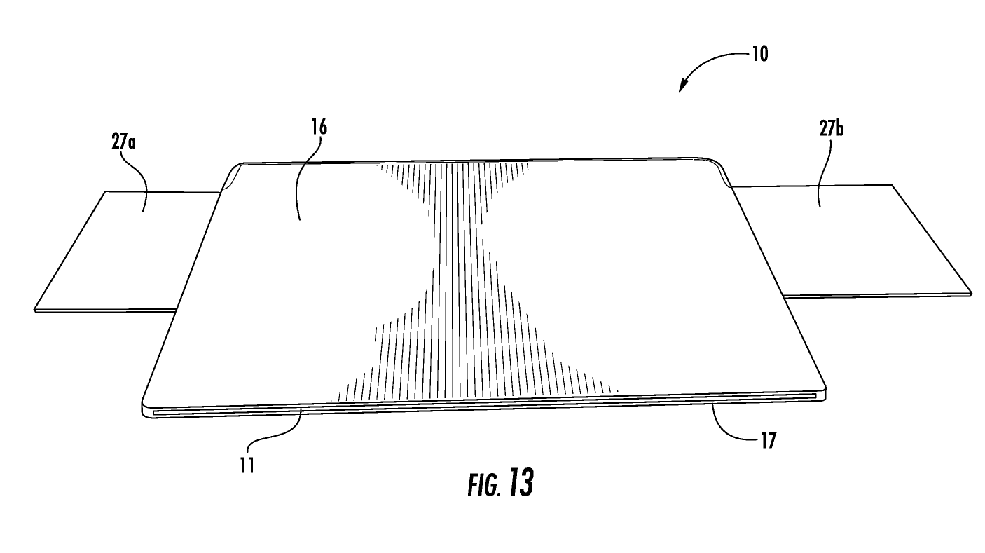

FIGS. 11 and 12 illustrate another exemplary embodiment of the disclosed device 10 wherein the device generally includes a top surface 16; a first retaining member 26a including a first retaining bar 28a slidably coupled to the top surface 16, and a first retaining lip 29a extending from the first retaining bar, the first retaining lip defining a longitudinally extending bottom surface 17a; a first longitudinal channel 30a formed between the top surface 16 and the first retaining lip 29a; a second retaining member 26b including a second retaining bar 28b slidably coupled to the top surface 16, and a second retaining lip 29b extending from the second retaining bar, the second retaining lip defining a longitudinally extending bottom surface 17b; and a second longitudinal channel 30b formed between the top surface 16 and the second retaining lip 29b; wherein the first longitudinal channel 30a and the second longitudinal channel 30b define a hand truck nose receiving slot 11 for receiving and retaining the load supporting nose 19 of a conventional hand truck. In this embodiment, the first retaining bar 28a may be attached to the top surface 16 via a fastener 12 disposed in an aperture 32 formed in the first retaining bar, wherein the aperture 32 defines an elongated hole for receiving and retaining the fastener 12, the aperture being arranged and configured to provide for lateral movement of the first retaining bar by loosening the fastener 12, laterally sliding the first retaining bar 28a and then tightening the fastener 12 to fix the first retaining bar in a desired position. Additionally, in this embodiment, the second retaining bar 28a may be attached to the top surface 16 via a fastener 12 disposed in an aperture 32 formed in the second retaining bar, wherein the aperture 32 defines an elongated hole for receiving and retaining the fastener 12, the aperture being arranged and configured to provide for lateral movement of the second retaining bar by loosening the fastener 12, laterally sliding the second retaining bar 28a and then tightening the fastener 12 to fix the second retaining bar in a desired position. As illustrated in FIGS. 11 and 12, the first retaining bar and the second retaining bar may each include two apertures, each configured to receive one fastener. In other embodiments, the first retaining bar and the second retaining bar may each include one aperture or a plurality of apertures, each aperture being configured for receiving and retaining a fastener, said fastener being adjustable from a fastened position, which holds the retaining bar in a securely fastened position, to an adjustable position which allows the retaining bar to be moved laterally to a desired position until the fastener is adjusted back into a fastened position. Other embodiments are contemplated wherein the first retaining bar and the second retaining bar are slidably coupled to the top surface using other means known to those skilled in the art. In these embodiments, the position of the first retaining bar and the position of the second retaining bar are adjustable so that the device can be used on multiple hand trucks having differently sized load supporting noses.

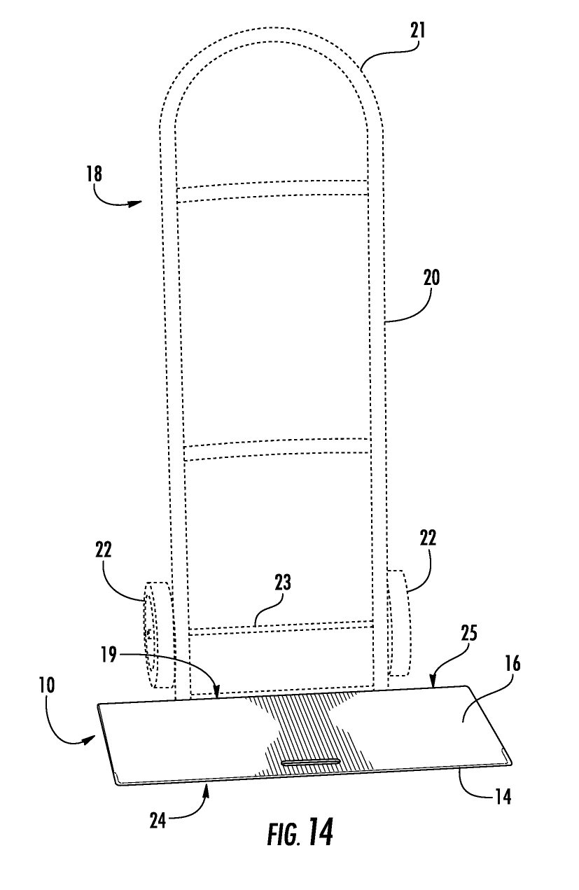

In the exemplary embodiment shown in FIG. 13, the device further includes a first wing member 27a coupled to the device and a second wing member 27b coupled to the device, wherein the wing members are independently extendable from between the top and bottom surface of the device. The first wing member and the second wing member may be pivotably coupled to the device. Alternatively, the first wing member and the second wing member may be slidably coupled to the device. The wing members provide an even greater surface area to the disclosed device.

FIG. 14 illustrates an exemplary embodiment of the disclosed device 10 attached to the load supporting nose 19 of a conventional hand truck 18. The hand truck 18 comprises an elongated frame 20 having a handle 21 formed at an upper end thereof, a load supporting nose or platform 19 that extends perpendicularly from a lower end thereof, and a pair of wheels 22 connected to the frame by an axle 23. In use, when a user pulls the handle toward himself or herself, the load supporting nose pivots upwardly and the frame is supported from the ground entirely by the wheels. As depicted in FIG. 14, when the disclosed device 10 is attached to the nose 19 of the hand truck, it provides an extended hand truck nose having a much larger surface area compared to the surface area of the conventional hand truck nose 19. This provides enhanced stability for moving large loads, which in turn provides for a safer method of moving large loads and decreases the risk of user injury.

It is important to note that the construction and arrangement of the elements of the device 10 provided herein are illustrative only. Although only a few exemplary embodiments of the present invention have been described in detail in this disclosure, those skilled in the art who review this disclosure will readily appreciate that many modifications are possible in these embodiments (such as variations in orientation of the components of the system, sizes, structures, shapes and proportions of the various components, etc.) without materially departing from the novel teachings and advantages of the invention.

Though the disclosed device 10 is illustrated in the accompanying Figures with its application for use with a conventional hand truck, note that it is not intended to limit the spirit and scope of the present invention solely for use in conjunction with hand trucks. The disclosed invention may be utilized with devices other than hand trucks and it may be used in a wide range of applications.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other features, modifications and variations are, therefore, considered to be a part of this invention, the scope of which is to be determined by the following claims.

The invention claimed is:

1. A hand truck nose extension device comprising:
a top surface;
a bottom surface coupled to said top surface; and
a hand truck nose receiving slot formed at a proximal end of said device and disposed between said top surface and said bottom surface, said hand truck nose receiving slot being configured for receiving and retaining a load supporting nose of a hand truck.

2. The hand truck nose extension device according to claim 1, further comprising an angled edge formed in the top surface at the distal end of said device, said angled edge defining an acute angle and being configured for sliding said distal end of said device under a load to be carried by said hand truck.

3. The hand truck nose extension device according to claim 1, wherein said top surface includes one or more textured portions being arranged and configured to create friction points on said top surface.

4. The hand truck nose extension device according to claim 1, wherein said top surface is made from a first sheet of metal and defines a flat planar surface, and wherein said bottom surface is made from a second sheet of metal and defines a flat planar surface.

5. The hand truck nose extension device according to claim 4, wherein said top surface and said bottom surface are permanently fixed together.

6. The hand truck nose extension device according to claim 1, wherein said top surface and said bottom surface are joined together in a manner which forms one or more openings between said top surface and said bottom surface.

7. The hand truck nose extension device according to claim 6, wherein one of said one or more openings between said top surface and said bottom surface defines said hand truck nose receiving slot between said top surface and said bottom surface.

8. The hand truck nose extension device according to claim 1, wherein said hand truck nose receiving slot is sized to retain said load supporting nose of said hand truck in said hand truck nose receiving slot by creating frictional contact between said top surface and said load supporting nose and by creating frictional contact between said bottom surface and said load supporting nose.

9. The hand truck nose extension device according to claim 1, wherein said top surface includes alternate ridges and grooves to create friction points on said top surface.

10. The hand truck nose extension device according to claim 1, wherein said device includes a corrugated surface defining an inner surface of said hand truck nose receiving slot.

11. The hand truck nose extension device according to claim 1, further comprising a first wing member coupled to said top surface and a second wing member coupled to said top surface, wherein said first wing member and said second wing member are independently extendable from between said top surface and said bottom surface.

12. The hand truck nose extension device according to claim 11, wherein said first wing member and said second wing member are pivotably coupled to said device.

13. The hand truck nose extension device according to claim 11, wherein said first wing member and said second wing member are slidably coupled to said device.

14. A hand truck nose extension device comprising:
a top surface;
a first retaining member comprising a first retaining bar fixed to said top surface, and a first retaining lip extending from said first retaining bar, said first retaining lip defining a longitudinally extending bottom surface;
a first longitudinal channel formed between said top surface and said first retaining lip;
a second retaining member including a second retaining bar fixed to said top surface, and a second retaining lip extending from said second retaining bar, said second retaining lip defining a longitudinally extending bottom surface; and
a second longitudinal channel formed between said top surface and said second retaining lip,
wherein said first longitudinal channel and said second longitudinal channel define a hand truck nose receiving slot for receiving and retaining a load supporting nose of a hand truck.

15. A hand truck nose extension device comprising:
a top surface;
a first retaining member comprising a first retaining bar slidably coupled to said top surface, and a first retaining lip extending from said first retaining bar, said first retaining lip defining a longitudinally extending bottom surface;
a first longitudinal channel formed between said top surface and said first retaining lip;
a second retaining member including a second retaining bar slidably coupled to said top surface, and a second retaining lip extending from said second retaining bar, said second retaining lip defining a longitudinally extending bottom surface; and
a second longitudinal channel formed between said top surface and said second retaining lip,
wherein said first longitudinal channel and said second longitudinal channel define a hand truck nose receiving slot for receiving and retaining a load supporting nose of a hand truck.

16. The hand truck nose extension device according to claim 15, wherein said first retaining bar is slidably coupled to said top surface via a fastener disposed in an aperture formed in said first retaining bar.

17. The hand truck nose extension device according to claim 16, wherein said aperture defines an elongated hole for receiving and retaining said fastener, said aperture being arranged and configured to provide for lateral movement of said first retaining bar.

18. The hand truck nose extension device according to claim 17, wherein said first retaining bar is moved laterally by a method comprising the following steps:
loosening said fastener;
laterally sliding said first retaining bar; and
tightening said fastener until said first retaining bar is fixed in a desired position.

19. The hand truck nose extension device according to claim 16, wherein said second retaining bar is slidably coupled to said top surface via a fastener disposed in an aperture formed in said second retaining bar.

20. The hand truck nose extension device according to claim 19, wherein said first retaining bar and said second retaining bar include one or more apertures, each aperture being configured for receiving and retaining a fastener, said fastener being adjustable from a fastened position to an adjustable position and back to said fastened position, wherein said fastened position defines a position of said fastener which holds said first retaining bar or said second retaining bar in a securely fastened position, and wherein said adjustable position defines a position of said fastener which allows said first retaining bar or said second retaining bar to be moved laterally to a desired position on said top surface.
